(19) United States
(12) Patent Application Publication
(10) Pub. No.: US 2005/0175320 A1
(43) Pub. Date: Aug. 11, 2005

(54) Broadcast program recording system, broadcast program recording method and broadcast program recording control method

(75) Inventor: Koji Miyazaki, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/049,285

(22) Filed: Feb. 3, 2005

(30) Foreign Application Priority Data
Feb. 6, 2004 (JP) 2004-030472

(51) Int. Cl. H04N 5/76; G06F 3/00; G06F 13/00

(52) U.S. Cl. 386/83; 725/58

(57) ABSTRACT

A digital broadcast tuner and a network compatible recorder are interconnected to make up a network. The recorder is adapted to record a video signal output from a video output terminal of the tuner. When a recording reservation for the recorder is made on the tuner, recording reservation data is sent to the recorder over the network and stored into its memory. The recorder carries out a program recording operation on the basis of the stored reservation data.

### CROSS-REFERENCE TO RELATED APPLICATIONS

This application is based upon and claims the benefit of priority from prior Japanese Patent Application No. 2004-030472, filed Feb. 6, 2004, the entire contents of which are incorporated herein by reference.

### BACKGROUND OF THE INVENTION

1. Field of the Invention

The present invention relates to a recording system to record programs, such as television broadcast programs and audio broadcast programs, which are broadcast on schedule. More particularly, the present invention relates to a broadcast program recording system, broadcast program recording method, and broadcast program recording control device which allow reserved programs to be recorded with certainty in an environment in which a receiver that receives broadcasts and a recorder that records the received broadcast programs are interconnected by a network utilizing Ethernet (registered trademark), by way of example.

2. Description of the Related Art

In recent years, various forms of television broadcasting have been adopted. That is, in addition to terrestrial analog broadcasting, satellite-based analog and digital broadcasting have been put into practice. Further, terrestrial digital broadcasting has also been started.

With digital broadcasting, it is possible not only to simply receive information provided from broadcasting stations but also to provide so-called interactive services that allow users to return responses to broadcast providers. For this reason, commercially available digital television sets or digital television tuners (set-top boxes) have a device built in which connects with servers on the side of broadcast providers to transmit data to them.

Recently, access to the Internet to obtain information over a telephone line by means of a personal computer has become widespread in ordinary households. It is not rare that two or more personal computers are used in a household. In such a case, an application has been found in connecting two or more personal computers to make up a domestic LAN (Local Area Network) with a router as a hub.

If such a LAN has been made up, it is effective to connect a digital television set to an external server through that LAN. Therefore, products that are equipped with Ethernet terminals have also come onto the market recently.

In the field of recorders, on the other hand, products, such as DVD (Digital Versatile Disk) recorders, have also appeared on the market which can connect with personal computers through a network to make recording reservations. It is expected that domestic LANs will be increasingly used in the future.

The main object of using recorders is to record broadcast programs. To this end, the recorders are equipped, though not entirely satisfactorily, with a tuner to receive broadcasts; however, they tend not to have a digital broadcasting compatible tuner built in.

To record digital broadcast programs, therefore, a method is used which involves supplying a signal received by a digital broadcast receiver to a line input of a recorder in the form of a digital signal as received or an analog signal after digital-to-analog conversion and, at the same time, starting recording.

To coordinate a digital broadcast receiver and a recorder in operation, there are two ways: one is to interconnect the digital broadcast receiver and the recorder with an IEEE 1394 serial bus and control the recorder using AV/C (Audio Video Control) commands, and the other is to transmit a remote control signal from the digital broadcast receiver to the recorder for control thereof.

In either case, recording reservations are made on the digital broadcast receiver side and the operation of the recorder is controlled by the digital broadcast receiver. A common method of making recording reservations is to create an EPG (Electronic Program Guide) program table on the basis of service information (SI) as metadata multiplex-transmitted in digital broadcasting, display it, and select a program to be recorded with a cursor.

As described above, the conventional system is configured such that, in recording, for example, a digital broadcast program by a recorder with no program receiving function, a recording reservation is made on a digital broadcast receiver and the operation of the recorder is controlled exclusively by the receiver.

In order for the recording operation to be carried out normally, therefore, it is required that the recorder be linked with and controlled correctly by the digital broadcast receiver at least from the time recording is started (broadcast start time) to the time the recording is ended (broadcast end time).

If, when a digital broadcast receiver, a recorder and so on are interconnected by an IEEE 1394 serial bus to set up a network, a bus reset occurs due to detachment of another piece of equipment from a connector, the state prior to the bus reset may not be restored. In that event, there arises a problem that the digital broadcast receiver is disabled from controlling the operation of the recorder.

In order for a digital broadcast receiver to send an infrared remote control signal to a recorder and control it, it is required that a light emitting unit of the receiver that emits the remote control signal and a light receiving unit of the recorder that receives the remote control signal be placed in a predetermined positional relationship. In the event of a displacement, the remote control signal is not transmitted correctly to the recorder. In addition, for remote control, it is required that the power to the recorder be kept off until the recording start time arrives. Otherwise, no correct recording operation could be expected.

In order to suppress the occurrence of such accidents, one might suggest entering recording reservation data into the recorder as well and causing the recorder to carry out a recording operation on the basis of that data. This method seems to be more reliable than the remote control method. However, making a recording reservation on each of the digital broadcast receiver and the recorder is time-consuming and hence has not been put into practice to date.

In, for example, in Japanese Unexamined Patent Publication No. 2001-136452 is disclosed a device which is adapted to obtain program information over a network, such as the Internet, using terminal equipment with no means for receiving data broadcasts and allow recording reservations. In this Publication, however, no information is given as to how to interconnect the receiver and the recorder to perform reserved recording with certainty.

As described above, to date, no system has been proposed which, in recording a program received by a broadcast receiver by a recorder liked with the receiver, allows that program to be recorded with certainty. The demand for such a system is increasing.

### BRIEF SUMMARY OF THE INVENTION

According to an aspect of the invention, there is provided a broadcast program recording system comprising: a receiver which receives a broadcast program; a recorder which is connected with the receiver through a network and supplied with a broadcast program signal received by and output from the receiver as a recording signal; a recording reservation unit which is provided in the receiver and creates recording reservation data which causes the receiver to receive a program to be broadcast in the future and the recorder to record that program; and a controller which transmits the recording reservation data from the recording reservation unit to the recorder over the network and causes the recorder to store the recording reservation data and perform a recording operation on the basis of the recording reservation data.

According to another aspect of the invention, there is provided a broadcast program recording method comprising: networking a receiver and a recorder which receives a broadcast program signal received by the receiver as a recording signal; inputting recording reservation data to cause the receiver to receive a program to be broadcast in the future and the recorder to record that program; entering the recording reservation data into each of the recorder and the receiver; and causing the receiver and the recorder to perform a receiving operation and a recording operation, respectively, on the basis of the entered recording reservation data.

According to a further aspect of the invention, there is provided a broadcast program control device comprising: an output unit which outputs a received broadcast program signal to outside so that it is recorded by a recorder; a communication unit which interconnects the output unit and the recorder to make up a network; a program reservation data input unit which is input with data to reserve the reception of a broadcast program to be broadcast in the future; and a control unit which sends the program reservation data to the recorder over the network in order to enter the program reservation data into the recorder.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of the entire configuration of a broadcast program recording system of the present invention;

FIG. 2 is a block diagram of the digital broadcast tuner in the system shown in FIG. 1;

FIG. 3 is a block diagram of the network compatible recorder in the system shown in FIG. 1;

FIG. 4 shows an exemplary key arrangement on a remote controller for use with the digital broadcasting tuner shown in FIG. 2;

FIG. 5 is a diagram for use in explanation of a procedure of registering the device of FIG. 3 with the digital broadcasting tuner;

FIG. 6 shows an exemplary EPG program table created from received signals by the digital broadcast tuner of FIG. 2;

FIG. 7 is a diagram for use in explanation of means for making a program recording reservation with the EPG program table shown in FIG. 6;

FIG. 8 is a diagram for use in explanation of means for making a program recording reservation with the EPG program table shown in FIG. 6;

FIG. 9 is a diagram for use in explanation of means for making a program recording reservation in the system shown in FIG. 1;

FIG. 10 is a diagram for use in explanation of means for making a program recording reservation in the system shown in FIG. 1;

FIG. 11 is a flowchart for use in explanation of registry means shown in FIG. 5;

FIG. 12 is a flowchart illustrating the operation of the digital broadcast receiver shown in FIG. 2;

FIG. 13 is a flowchart illustrating the operation of the recorder shown in FIG. 3;

FIG. 14 is a flowchart illustrating the operation of the digital broadcast receiver shown in FIG. 2; and

FIG. 15 is a flowchart illustrating the operation of the recorder shown in FIG. 3.

### DETAILED DESCRIPTION OF THE INVENTION

An embodiment of a broadcast program recording system of the present invention will be described in detail hereinafter with reference to the accompanying drawings.

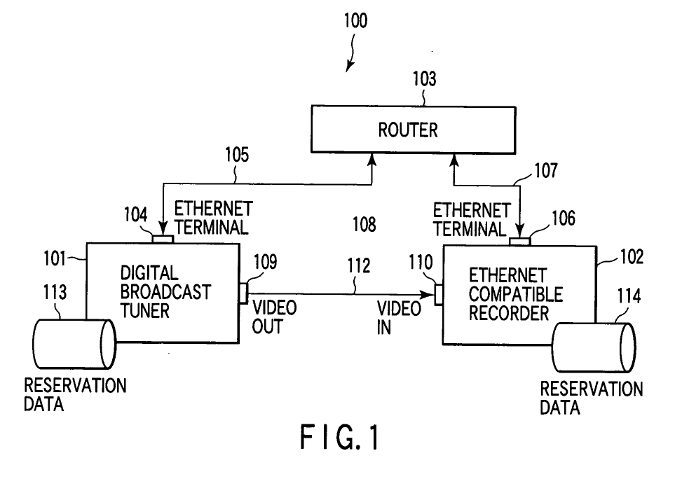

FIG. 1 is a conceptual block diagram of the broadcast program recording system, indicated generally at 100, of the present invention, which is composed of a digital broadcast tuner 101 as a broadcast receiver, a network compatible recorder 102 as a recorder, and a router 103 for networking the tuner 101 and the tuner 102.

The digital broadcast tuner 101 has a terminal 104 adapted for a network, such as Ethernet, and is connected to the router 103 by a cable 105. Likewise, the network compatible recorder 102 has a network terminal 106 and is connected to the router 103 by a cable 107. Thus, the digital broadcast tuner 101 and the network compatible recorder 102 are interconnected to make up a network 108.

The digital broadcast tuner 101 is equipped with a video output terminal 109 from which a video signal (including an audio signal as well) corresponding to a received program is output. The network compatible recorder 102 is equipped with a video input terminal 110 for receiving that video signal. The terminals 109 and 110 are connected together by a cable 112. The video input terminal 110 is a so-called line input terminal. Normally, two or more line input terminals are provided.

The digital broadcast tuner 101 and the network compatible recorder 102 are equipped with memories 113 and 114, respectively. Each of the memories is comprised of a flash memory. When a recording reservation is made on the digital broadcast tuner 101, all or part of the reservation data is sent over the network 108 to the network compatible recorder 102 and then stored in the memory 114. That is, the reservation data is entered into the recorder.

The network compatible recorder 102, upon completion of entry of the reservation data, sends notification of completion to the digital broadcast tuner 101. In response to this notification, the digital broadcast receiver 101 enters the reservation data into the memory 113.

The reservation data entered into the memory 113 of the digital broadcast tuner 101 includes the channel number of a broadcasting station that broadcasts a program the user wants to record, the recording start and end times (broadcasting start and end times), the recording video mode, and the recording audio mode. In the network compatible recorder 102, the reservation data includes the number of a terminal of two or more line input terminals which is connected to the video output terminal 109 of the digital broadcast tuner 101, the recording start and end times, the recording video mode, and the recording audio mode.

At the same time the broadcasting of the reserved program is started, the digital broadcast tuner 101 is activated. As a result, the broadcasting channel for the reserved program is selected, then the received signal is demodulated and converted into an MPEG (Moving Picture Experts Group)-2 TS (Transport Stream) signal, and processing corresponding to the recording video and audio modes in the reservation data is performed on the TS signal as needed. The resulting signal is output at the video output terminal 109.

That is, from the video output terminal 109 is output the TS signal itself or an analog video signal (video signal plus audio signal) produced by decoding the TS signal and NTSC encoding the decoded signal.

At the same time the broadcasting of the reserved program is started, the network compatible recorder 102 records the video signal applied to the video input terminal 110 having the reserved line number onto a recording medium (not shown) loaded into it in the reserved recording video and audio modes.

When the broadcasting end time arrives, the digital broadcast tuner 101 stops the receiving operation and the network compatible recorder 102 stops the recording operation.

According to the broadcast program recording system of the present invention, as described above, when a recording reservation is made on the broadcast receiver, all or part of the reservation data is stored over the network into the network compatible recorder 102. As a result, the recorder operates on the basis of the stored reservation data without being affected by the broadcast receiver. That is, at least the activation of the recorder can be carried out reliably with no malfunction.

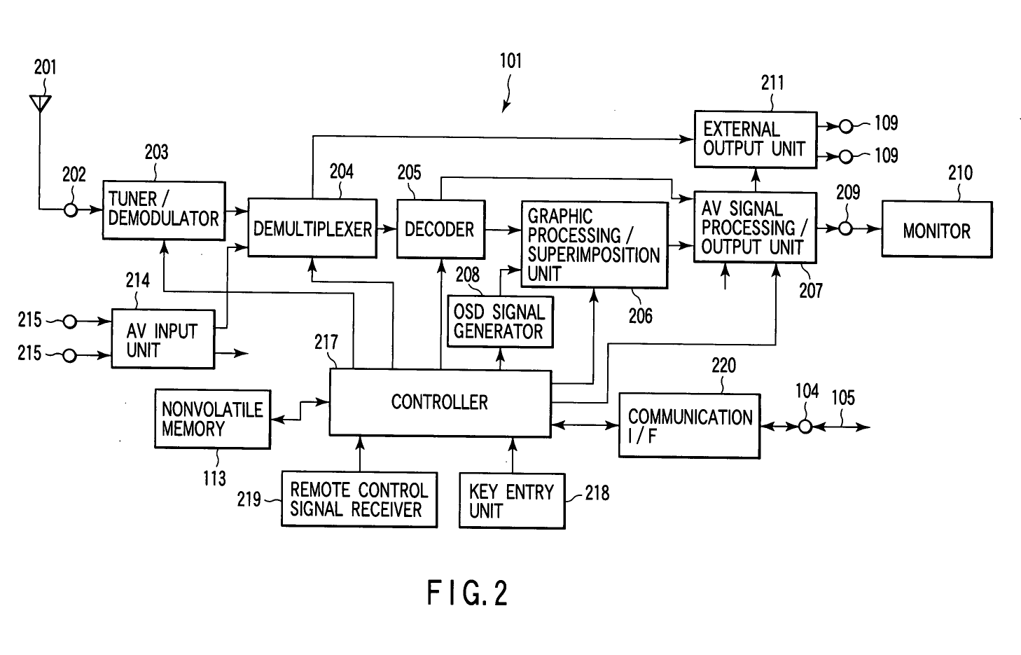

FIG. 2 is a block diagram of the digital broadcast tuner 101 shown in FIG. 1. In this diagram, corresponding components to those in FIG. 1 are denoted by like reference numerals. In FIG. 2, 201 denotes an antenna by which broadcast signals are picked up. The broadcast signals are applied through an antenna input terminal 207 to a tuner/demodulator 203.

The tuner/demodulator 203 selects a desired broadcast channel and performs processes, such as demodulation, error correction, descrambling, etc., on the received signal on the selected channel. The resulting signal is output as an MPEG-2 TS signal.

The TS signal from the tuner/demodulator 203 is applied to a demultiplexer 204 where multiplexed data are separated for each packet. The PESs (Packetized Elementary Streams) that constitute video and audio of the program are applied to a decoder 205 where they are decoded and output as non-compressed digital video and audio signals.

The digital video signal from the decoder 205 is applied to a graphic processing/superimposition unit 206 where it undergoes graphic processing and super-imposition processing of an OSD (On Screen Display) signal from an OSD signal generator 207. The resulting digital video signal is then applied to an AV (Audio Video) signal processing/outputting unit 208. The digital audio signal output from the decoder 205 is also applied to the AV signal processing/outputting unit 208.

In the AV signal processing/outputting unit 207, the digital video signal and the digital audio signal are converted into a television signal of a standard format and an analog baseband television signal is produced. The television signal output from the AV signal processing/outputting unit 208 is applied through an output terminal 209 to a monitor 210. The television pictures are displayed on the display screen of the monitor 210 and the audio is output from a loudspeaker.

The TS signal separated and extracted by the demultiplexer 204 is output to an external output unit 211 as well. The analog baseband television signal from the AV signal processing/outputting unit 208 is also applied to the external output unit 211. The output unit outputs the digital TS signal digital at a terminal 109 and the analog television signal at a separate terminal 109. The terminals 109 corresponds to the video output terminal 109 shown in FIG. 1.

Further, the digital broadcast tuner 101 is equipped with an AV input unit 214 to receive an externally applied television signal and present it on the monitor 210. The AV input unit 214 has two input terminals 215: one for an MPEG TS signal of digital form and one for an analog television signal. The digital signal from the AV input unit is applied to the demultiplexer 204 where it is processed in the same manner as TS output from the tuner/demodulator 203. On the other hand, the analog television signal from the AV input unit is applied through the AV signal processing/outputting unit 208 to the monitor 210.

Moreover, the digital broadcast tuner 101 is provided with a controller 217 for overall operation control and data management. The controller is comprised of a microcomputer and includes a ROM (Read Only Memory) stored with processing programs, such as applications, and a RAM (Random Access Memory) as a work area.

The controller 217 controls the tuner/demodulator 203, the demultiplexer 204, the decoder 205, the graphic processing/superimposition unit 207, and the AV signal processing/outputting unit 208. Further, the controller causes the OSD signal generator 207 to generate an OSD signal and analyzes SI separated by the demultiplexer 204 to create an EPG program table. The resulting program table is sent from the OSD signal processing unit 207 through the graphic processing/superimposition unit 207 and the AV signal processing/outputting unit 208 to the monitor 210 and displayed on the monitor.

To send and receive data over the network, the controller 217 is connected with a communication I/F 220, which is connected through the network terminal 104 to the router 103 (see FIG. 1) by the cable 105.

To the controller 217 are connected a key entry unit 218 and a remote control signal receiver 219, which are adapted to set the operations and adjust the functions of the digital broadcast tuner 101. When operating the key entry unit 218 or a remote controller not shown, the user is allowed to control switching of the channels by the tuner/demodulator 203 and switching of screen configurations and superimposition of an OSD signal by the graphic processing/superimposition unit 206.

Furthermore, operating the key entry unit 218 or the remote controller allows recording reservations of programs which will be broadcast in the future. The input reservation data is stored in the nonvolatile memory 113, whereupon the recording reservation is completed.

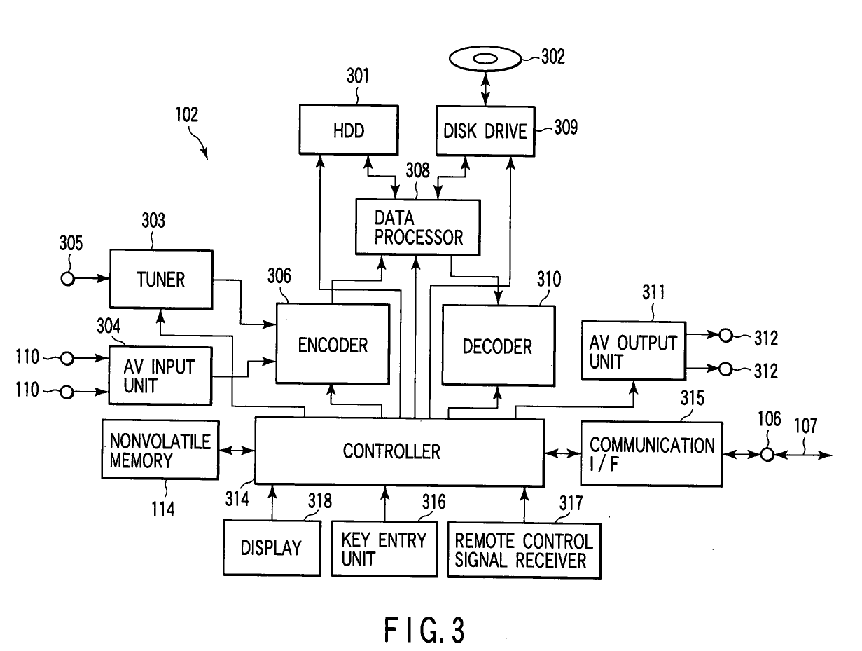

FIG. 3 illustrates, in block form, an exemplary arrangement of the network compatible recorder 103 shown in FIG. 1. In this diagram, corresponding components to those in FIG. 1 are denoted by like reference numerals. The recorder 103 shown in FIG. 3 is configured so that an HDD (Hard Disk Drive) 301 and an optical disk 302 can be handled as recording media.

The recorder is equipped with a tuner 303 that receives an analog broadcast and an AV input unit 304 that receives an externally applied television signal as sources of television signals to be recorded.

The tuner 303 receives broadcast signals applied to an RF (Radio Frequency) input terminal 305, then selects a desired channel and converts the selected broadcast signal into an analog baseband television signal through demodulation. The resulting television signal is applied to an encoder 306.

The AV input unit 304 also supplies an analog television signal or digital television signal externally applied through input terminal means 110 to the encoder 305. The input terminal means 110 is comprised of two input terminals: one for the digital television signal and one for the analog television signal. This input terminal means corresponds to the video input terminal 110 shown in FIG. 1.

The encoder 306 converts the video and audio signals in the input analog television signal into digital signals and then performs processes of encoding and format conversion on the digital signals. The resulting digital signals are applied to a data processor 308, which performs a process of recording the digital data supplied from the encoder 306 onto a hard disk in the HDD 301 or an optical disk 302 in the disk drive 309. In addition, the data processor 308 reads data recorded on the hard disk or optical disk and supplies it to a decoder 310.

The decoder 310 restores the formats of input video and audio data to their original states and then outputs the resulting data as a digital television signal to an AV output unit 311 which has two output terminals 312. The AV output unit outputs the digital television signal as a TS signal to one of the output terminals 312 or the corresponding analog television signal resulting from digital-to-analog conversion of the digital television signal to the other of the output terminals.

To control the overall operation of the network compatible recorder 102, a controller 314 is provided which is comprised of a microcomputer. The controller 314 controls the tuner 303 for channel selection, the encoder 306, the data processor 308, the HDD 301, the disk driver 309, the decoder 310, and the AV output unit 311. The controller 314 is equipped with a ROM stored with various processing programs, such as applications, and a RAM for work area.

To the controller 314 is connected a communication I/F 315 for data communications over the network. The communication I/F 315 is connected through the network terminal 106 to the router 103 (see FIG. 1) by the cable 107.

To the controller 314 are connected a key entry unit 316 and a remote control signal receiver 317 to allow the user to set operations and make function adjustments. When the user operates the key entry unit 316 or the remote controller (not shown), switching of the channels in the tuner 303, selection between the recording media at the time of recording or playback, record mode selection, title selection on playback, and so on are carried out. Furthermore, to the controller 314 are connected a display unit 318 and a nonvolatile memory 114. The display unit displays the operating states of the network compatible recorder 102. The nonvolatile memory 114 stores various pieces of setting information and all or part of the recording reservation data sent from the digital broadcast tuner 101 over the network 108.

The digital broadcast tuner 101 and the network compatible recorder 102 thus configured are connected together to the router 102 to thereby make up the network 108. In practice, however, there is a need for a process of connecting the network compatible recorder 102 to the network. This will be described below.

That is, at the stage of initialization, the network compatible recorder 102 must be registered with the digital broadcast tuner 101 as recognizable equipment. To this end, for example, an initialization menu is first displayed on the monitor 210 of the digital broadcast tuner 101 by operating the remote controller not shown or the like. Using this menu, the recorder is registered with the tuner.

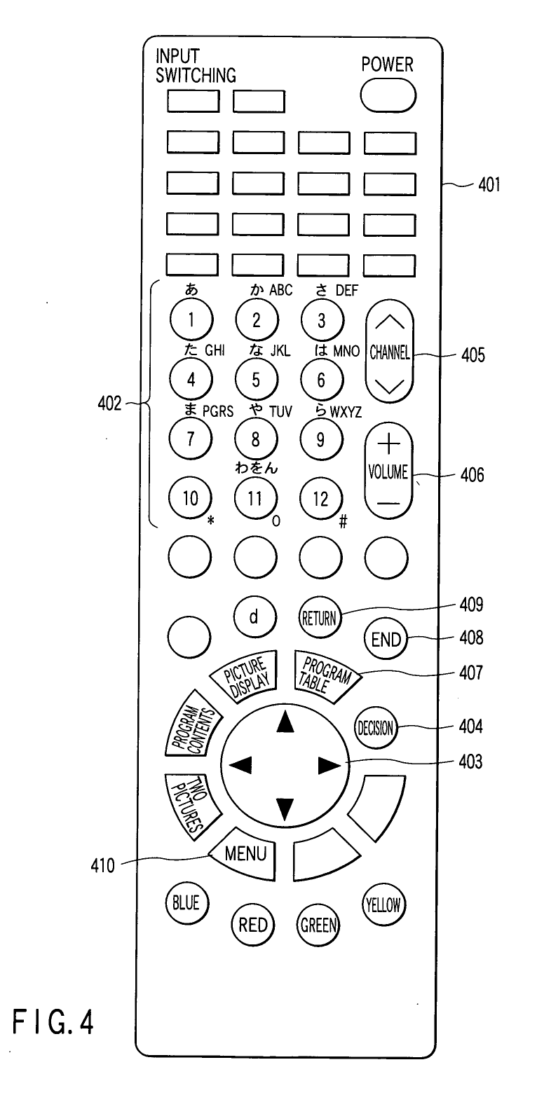

FIG. 4 shows an exemplary key arrangement of a remote controller 401 for controlling the digital broadcast tuner 101. The remote controller 401 has numeric keys 402 used in switching terrestrial broadcast channels or entering numeric/character data. The numeric keys 402 comprises 12 keys with FIGS. 1 through 12. Further, each of the keys is allocated kana characters (Japanese phonetic alphabets characters) and alphabetic characters. As an example, the key with 1 is allocated all the kana characters in the [symbol] (A) line and alphabetic characters “A, B, and C” and their lower cases. Pressing the key allows one of these characters to be entered.

The remote controller 401 further includes a cursor key 403 adapted to make a selection from items on the screen, a decision key 404 adapted to allow an item or items selected with the cursor key 403 to be entered, a channel up/down key 405 adapted to make channel selection in the direction in which the channel number increases (up) or decreases (down), and a volume adjust key 406 to turn the volume of sound up or down.

The remote controller 401 further includes a program table key 407 adapted to allow an EPG table to be displayed on the screen, a terminate key 408 to terminate processing, a return key 409 used in returning the display screen, and a menu key 410 adapted to allow a menu for setting various functions to be displayed on the screen.

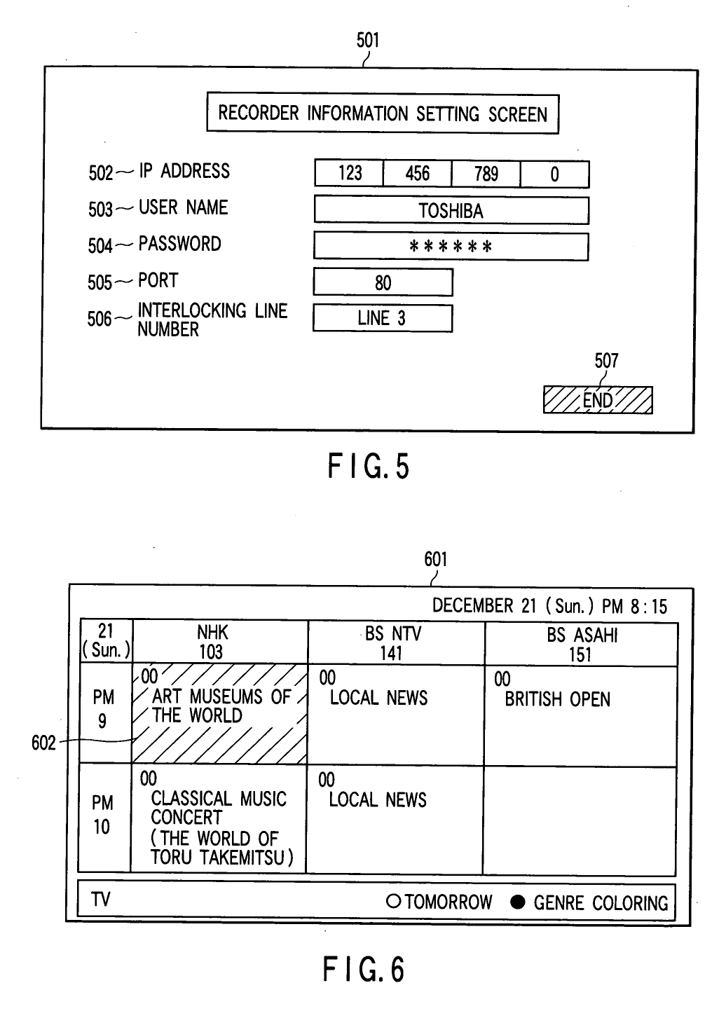

FIG. 5 shows an exemplary display screen for registry of the network compatible recorder 102. On screen 501 are provided an IP (Internet Protocol) address box 502, a user's name box 503, a password box 504, a port number box 505, an interlocking line number box 506, and a setting completion button 507 which is operated (clicked) upon completion of setting.

When operating the menu key 410 of the remote controller 401, the user is allowed to go from the initialization menu to a recorder information setting screen shown in FIG. 5 and fill in the blanks using the numeric and character keys 402 on the remote controller 401. Upon completion of filling in all the blanks, the user operates the cursor key 403 on the remote controller 401 to position the cursor on the setting completion key 507 and then clicks on the decision key 404, whereby the process of registering the network compatible recorder 102 with the digital broadcast tuner 101 is completed To make a recording reservation in the state where the network 108 has been made up in the above manner, the user first operates the program table key 407 on the remote controller 401. The controller 217 of the digital broadcast tuner 101 then receives the remote control signal from the remote controller 401 via the remote control signal receiver 219. As a result, the controller extracts multiplex-transmitted SI in the demultiplexer 204 and decodes it to create an EPG program table and then sends the program table to the graphic processing/superimposition unit 206 through the OSD signal generator 208 and display it on the screen.

FIG. 6 shows an example of an EPG program table 601. The user positions the cursor on a desired program using the cursor key 403 on the remote controller 401 and then clicks on the decision key 404.

FIG. 6 indicates that the cursor 602 is present on a program “Art Museums of the World” which is broadcast from 9 to 10 p.m. on December 21 on Channel 103 by satellite digital broadcasting. Operating the decision key 404 in this state allows the recording reservation screen to appear.

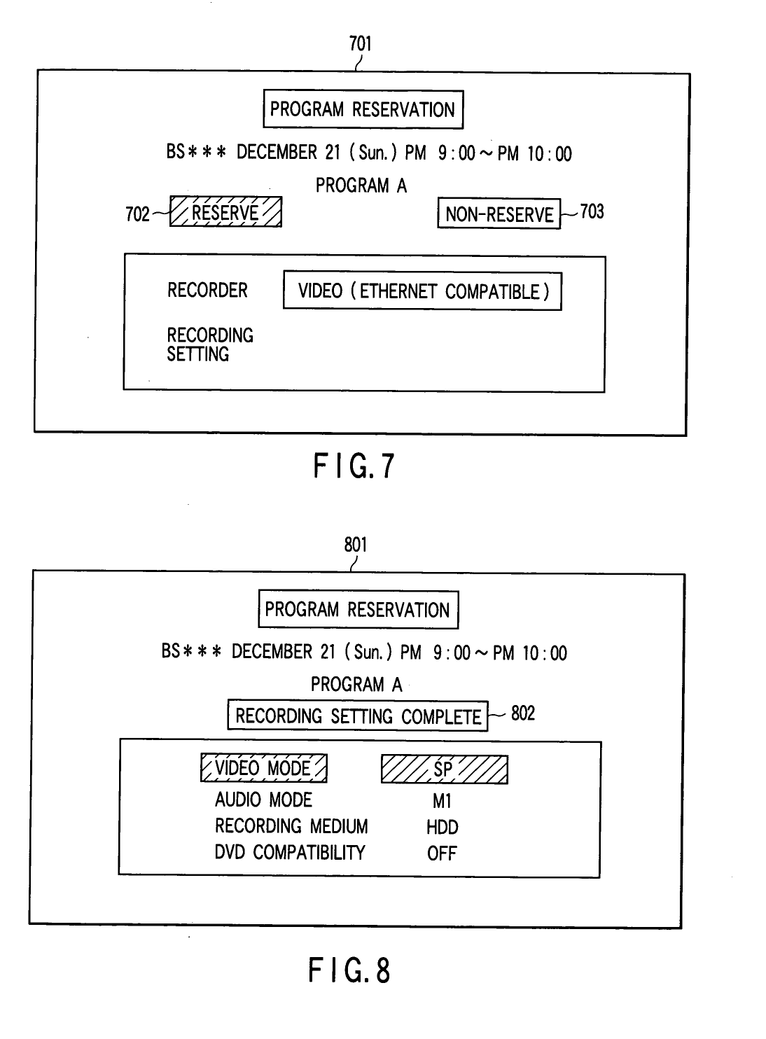

FIG. 7 shows an example display screen for recording reservation. On screen 701 the broadcasting channel and date and time of the selected program are displayed immediately under the title of program recording reservation. Further, the title of the program, “Reserve” select box 702 and “Non-Reserve” select box 703 are displayed. In the lowest portion of the screen, information about the recorder is displayed.

If the user selects “Reserve” using the cursor key 403 and the decision key 404, then the screen shown in FIG. 8 appears. Recording conditions are set up on the screen 801 of FIG. 8. Setting items include “Video Mode”, “Audio Mode”, “Recording Medium”, and “DVD Compatibility”. The Video Mode is the picture quality of video upon playback and SP (Standard Playing (record)) is the standard mode. The Audio Mode is the sound quality upon playback and M1 is the standard sound quality. The Recording Medium indicates which of the HDD 301 and the optical disk 302 recording is to be made on. The DVD Compatibility indicates whether or not to make recording with compatibility with another DVD format kept.

After completion of setting of the recording condition items, the recording reservation is completed by clicking on a recording reservation setting completion button 802.

Upon receipt of information that the recording reservation setting has been completed, the controller 217 sends the set reservation data to the network compatible recorder 102 over the network 108 so that it is stored into the nonvolatile memory 113 of the digital broadcast tuner 101.

In the network compatible recorder 102, the reservation data sent over the network 108 is stored into the nonvolatile memory 114 under the control of the controller 314. The reservation data includes not only the data sent from the digital broadcast tuner 101 but also the line number set upon initialization. That is, the line number selected in the AV input unit 304 is included.

Thus, by entering the recording reservation data created in the digital broadcast tuner 101 into the network compatible recorder 102 as well, the recording operation can be made more reliable.

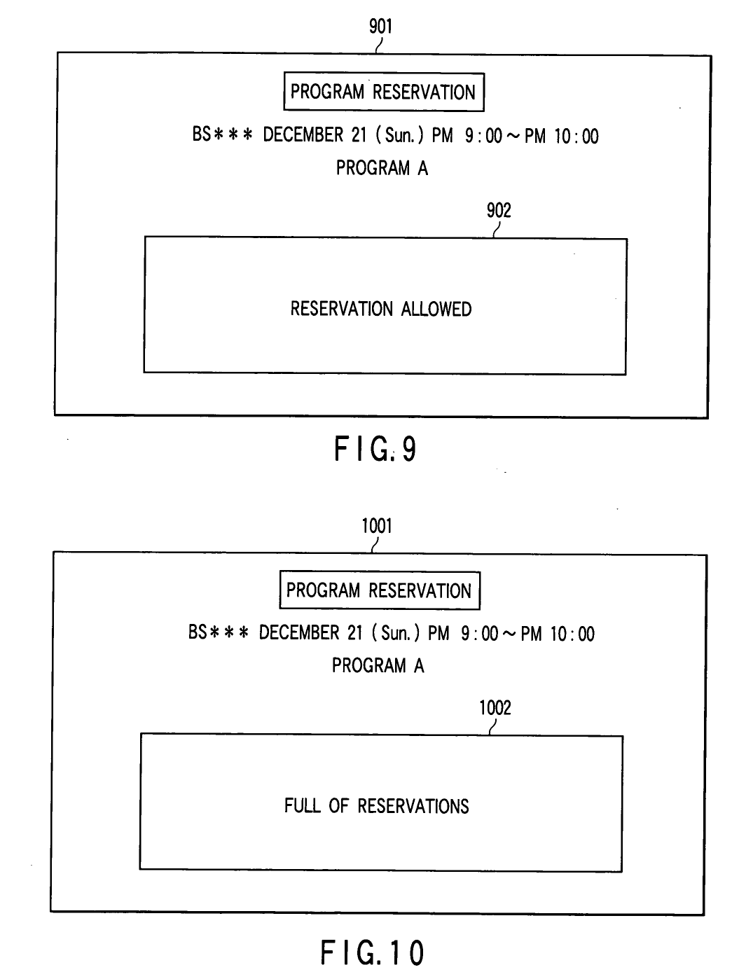

After the recording reservation data from the digital broadcast tuner 101 has been entered into the network compatible recorder 102, the recorder returns a message to the tuner that entry of the reservation data has been completed. Thus, the tuner can confirm that the recording reservation has been made without error. To notify the user of such a situation, the digital broadcast tuner 101 can be configured to cause the monitor 210 to display such a message as shown in FIG. 9.

In FIG. 9, the specific contents of the reserved program are displayed in the upper portion of screen 901 and a message 902 that the reservation has been completed is displayed in the lower portion. This allows the user to confirm that the recording reservation has been made correctly. This also allows the prevention of accidents such as recording reservations not being made normally due to wrong data entry.

With ordinary commercially-available equipment, a limit is imposed on the number of programs that can be reserved for recording. Even if the user tries to reserve more programs than the limit, the equipment is usually configured to deny excess reservations. In such a case as well, it is desired that the user be notified.

That is, as shown in FIG. 10, a message 1002 that the recorder is full of recording reservations is displayed in the lower portion of screen 1001 if, in making a recording reservation, reservations have already been made to the limit.

In this case, upon receipt of reservation data from the digital broadcast tuner 101, the network compatible recorder 102 confirms the number of programs already reserved and, in the event that programs have been reserved to the limit, sends a message to that effect to the tuner. The tuner then creates such a message as shown in FIG. 10 and displays it on the monitor 210.

Thus, by notifying the user that an additional reservation cannot be made, it becomes possible to prevent an accident such as recording not being carried out despite a reservation having been made.

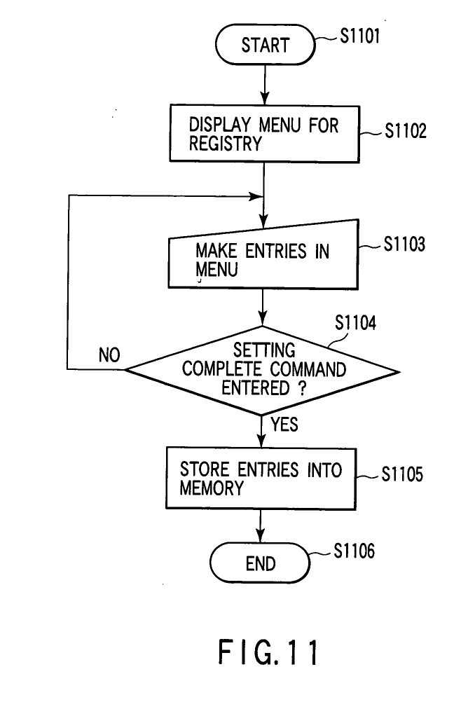

FIGS. 11 through 15 are flowcharts illustrating the operations of the broadcast program recording system of the present invention described so far. FIG. 11 illustrates the process of connecting the network compatible recorder 101 to the network. A start is made in step S1101, a menu for registering the recorder with the tuner is displayed in step S1102, and entries are made in the menu in step S1103. In step S1102, a decision is made as to whether or not a setting completion command has been entered. If the command has been entered, then the entries are stored into the nonvolatile memory 114 in step S1105 and the processing ends in step S1106.

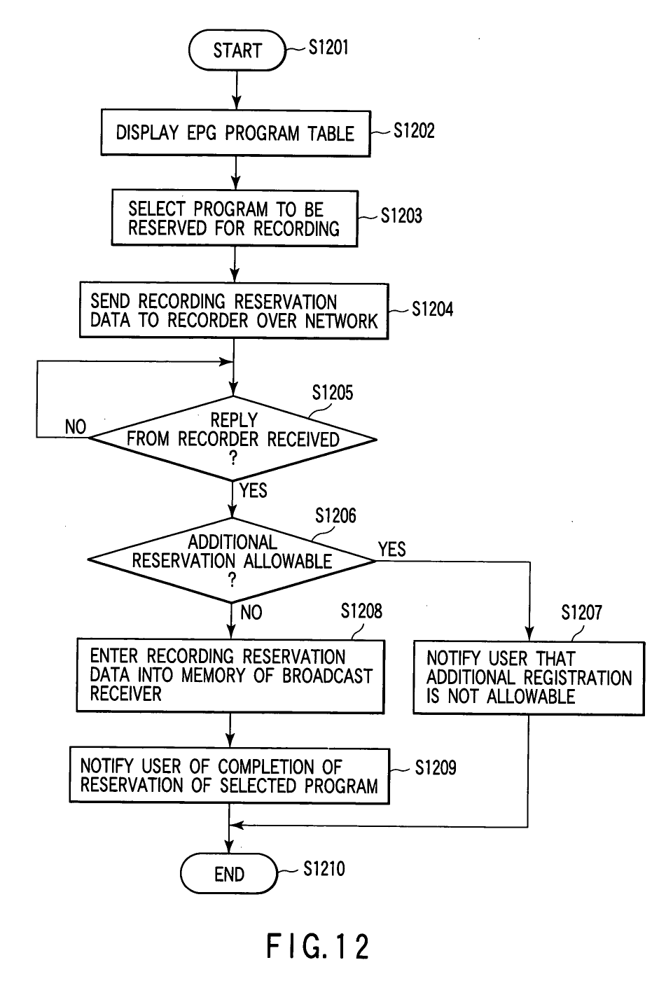

FIG. 12 is a flowchart illustrating the process of entering recording reservation data into the recorder by the digital television receiver. A start is made in step S1201, an EPG program table is displayed in step S1202, and a program for which the user wants to make a recording reservation is selected in that program table in S1203. In step S1204, the recording reservation data is sent to the recorder over the network.

In step S1205, a decision is made as to whether or not a reply message has been received from the recorder. If the message has been received, then a decision is made in step S1205 as to whether or not its contents are that an additional reservation is not allowable. If not allowable, then a message is displayed on the monitor in step S1207 to notify the user that programs have been reserved to the limit and hence an additional reservation is not allowable. The processing ends in step S1210.

If allowable in step S1206, since the recording reservation has been accepted by the recorder, the procedure goes to step S1203 in which the recording reservation data is entered into the broadcast receiver. In step S1209, a message is displayed on the monitor to notify the user that the recording reservation of the selected program has been completed. The processing ends in step S1210.

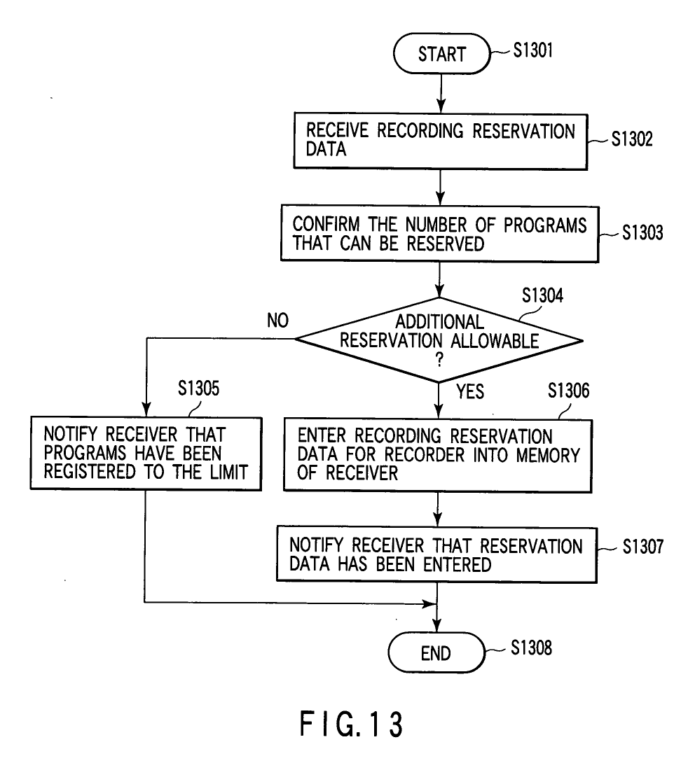

FIG. 13 is a flowchart illustrating the processing of entering recording reservation data into the digital broadcast recorder. A start is made in step S1301, and recording reservation data is received from the television receiver in step S1302. The number of programs that can be reserved for recording is confirmed in step S1303. A decision is then made in step S1304 as to whether or not an additional reservation is allowable. If not allowable, a message that an additional reservation is not allowable is sent to the receiver in step S1305. The processing ends in step S1308.

If allowable in step S1304, recording reservation data for the recorder is created based on the received reservation data and entered in the recorder in step S1306. In step S1307 the recorder sends to the receiver a message that the recording reservation data has been entered. The processing ends in step S1308.

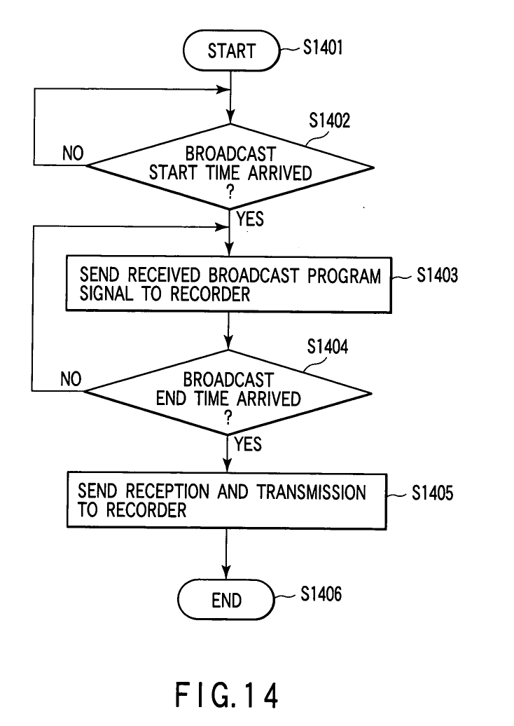

FIG. 14 is a flowchart illustrating the procedure for the digital broadcast tuner 101 to receive a broadcast program on the basis of recording reservation data. A start is made in step S1401 and a decision is made in step S1402 as to whether or not the time when the broadcasting of the reserved program begins has arrived. If arrived, the broadcast program reserved in step S1403 is received and the received signal is sent to the recorder in step S1403.

In step S1404, a decision is made as to whether or not the broadcast end time has arrived. If arrived, the reception of the program and the transmission to the recorder are stopped in step S1405. The processing ends in step S1406.

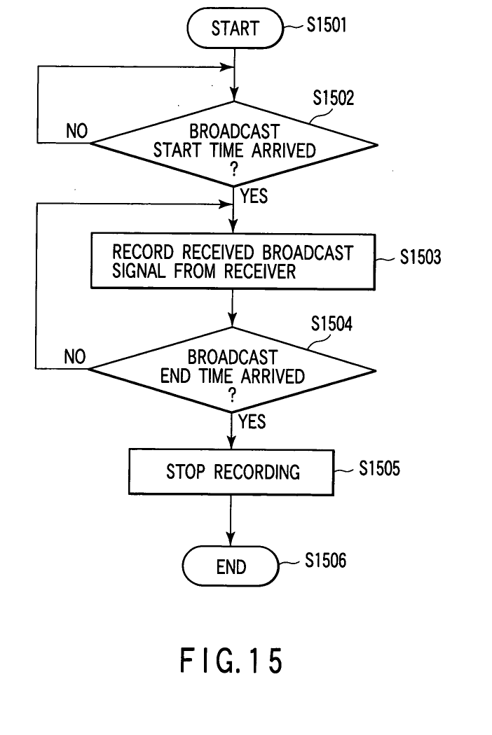

FIG. 15 is a flowchart illustrating the procedure for the recorder 102 to record a broadcast program on the basis of recording reservation data. A start is made in step S1501 and a decision is then made in step S1502 as to whether or not the broadcast start time for the reserved program has arrived. If arrived, the received signal for the reserved broadcast program sent from the digital broadcast tuner 101 is received and recorded on a recording medium in step S1503.

In step S1504, a decision is made as to whether or not the program end time has arrived. If arrived, then the recording is stopped in step S1505 and the processing ends in step S1504.

According to the broadcast program recording system of the present invention, as described above, recording reservation data is also entered into a recorder networked with a television receiver and recording is carried out on the basis of the reservation data; therefore, reserved programs can be recorded with certainty.

Although the embodiment of the present invention has been described as a system for recording television broadcast programs, the invention is not limited to recording of television broadcasts. For example, the inventive system can be adapted to record audio broadcasts or data broadcasts.

The invention involves networking a broadcast receiver and a recorder, entering recording reservation data not only into the broadcast receiver but also into the recorder in making a reservation for recording of a program received by the broadcast receiver by means of the recorder, and causing the recorder to carry out the recording on the basis of the entered reservation data.

According to the present invention, recording reservation data is also entered into the recorder, thus allowing a recording operation to be carried out with certainty.

1. A broadcast program recording system comprising:
a receiver which receives a broadcast program;
a recorder which is connected with the receiver through a network and supplied with a broadcast program signal received by and output from the receiver as a recording signal;
a recording reservation unit which is provided in the receiver and creates recording reservation data which causes the receiver to receive a program to be broadcast in the future and the recorder to record that program; and
a controller which transmits the recording reservation data from the recording reservation unit to the recorder over the network and causes the recorder to store the recording reservation data and perform a recording operation on the basis of the recording reservation data.

2. The broadcast program recording system according to claim 1, wherein the recorder includes a unit which notifies the receiver over the network that the storage of the recording reservation data received over the network has been completed.

3. The broadcast program recording system according to claim 1, wherein the recorder includes a unit which notifies the receiver over the network that the storage of the recording reservation data received over the network is not carried out.

4. The broadcast program recording system according to claim 2, wherein the receiver includes a display unit which displays a message based on the notification received from the recorder over the network.

5. The broadcast program recording system according to claim 3, wherein the receiver includes a display unit which displays a message based on the notification received from the recorder over the network.

6. A broadcast program recording method comprising:
networking a receiver and a recorder which receives a broadcast program signal received by the receiver as a recording signal;
inputting recording reservation data to cause the receiver to receive a program to be broadcast in the future and the recorder to record that program;
entering the recording reservation data into each of the recorder and the receiver; and
causing the receiver and the recorder to perform a receiving operation and a recording operation, respectively, on the basis of the entered recording reservation data.

7. A broadcast program control device comprising:
an output unit which outputs a received broadcast program signal to outside so that it is recorded by a recorder;
a communication unit which interconnects the output unit and the recorder to make up a network;
a program reservation data input unit which is input with data to reserve the reception of a broadcast program to be broadcast in the future; and
a control unit which sends the program reservation data to the recorder over the network in order to enter the program reservation data into the recorder.
